(19) United States
(12) Patent Application Publication
(10) Pub. No.: US 2006/0259781 A1
(43) Pub. Date: Nov. 16, 2006

(54) Method and apparatus for detecting the falsification of metadata

(75) Inventors: Keiko Saeki, Tokyo (JP); Motomasa Futagami, San Jose, CA (US); Toshihiro Ishizaka, Tokyo (JP)

Correspondence Address: FITCH EVEN TABIN & FLANNERY, 120 SOUTH LASALLE SUITE 1600, CHICAGO, IL, 60603, US

(73) Assignee: Sony Corporation/Sony Electronics Inc.

(21) Appl. No.: 11/117,985

(22) Filed: Apr. 29, 2005

(51) Int. Cl. G06F 12/14

(52) U.S. Cl. 713/189

(57) ABSTRACT

There are disclosed methods and systems (and related data structures) for processing metadata in files, including media files, so that an alteration or falsification of the metadata can be detected. According to certain embodiments, the metadata includes hash values and digital signatures that were generated by a content server. These hash values and digital signatures can be used by a client device to authenticate the metadata.

### 1. FIELD OF INVENTION

This relates to a data structure of files, including media files, and methods and systems for detecting the falsification of certain metadata related to the files.

### 2. BACKGROUND

Providers of digital video content, audio content or other types of content often are reluctant to deliver this content over the Internet without effective content protection. While the technology exists for content providers to provide content over the Internet, digital content by its very nature is easy to duplicate or alter either with or without the owner's authorization. The Internet allows the delivery of the content from the owner, but that same technology also permits widespread distribution of unauthorized, duplicated content.

Digital Rights Management (DRM) is a digital content protection model that has grown in use in recent years as a means for protecting file distribution. DRM usually encompasses a complex set of technologies and business models to protect digital media or other data and to provide revenue to content owners.

Many known DRM systems use a storage device, such as a hard disk drive component of a computer, that contains a collection of unencrypted content (or other data) provided by content owners. The content in the storage device resides within a trusted area behind a firewall. Within the trusted area, the content residing on the storage device can be encrypted. A content server receives encrypted content from the storage device and packages the encrypted content for distribution. A license server holds a description of rights and usage rules associated with the encrypted content, as well as associated encryption keys. (The content server and license server are sometimes part of a content provider system that is owned or controlled by a content provider (such as a studio) or by a service provider.) A playback device or client receives the encrypted content from the content server for display and receives a license specifying access rights from the license server.

Some DRM processes consist of requesting an item of content, encrypting the item with a content key, storing the content key in a content digital license, distributing the encrypted content to a playback device, delivering a digital license file that includes the content key to the playback device, and decrypting the content file and playing it under the usage rules specified in the digital license.

For certain types of content, however, especially multimedia files, content providers may not desire that the entire item of content be encrypted prior to delivery to a user. In many multimedia files, for example, a portion of each file is devoted to metadata which is used to identify the title of the work, the artist, and other information about the underlying audio-visual content itself. Some content providers do not desire that this type of metadata be encrypted along with the content itself, since they deem it desirable that potential users have access to this type of metadata in order to make a purchase decision, etc. prior to ordering and receiving a license with the associated decryption keys.

On the other hand, releasing an item of content without encrypting the metadata can present problems. A malicious user could alter the unencrypted metadata and thereby cause confusion, generate erroneous purchases or create other problems. For example, a malicious user could alter the metadata of an item of multimedia content so that the metadata reflects an incorrect title of the underlying content. Thus when an innocent user reads the altered metadata and purchases a license for a title of content as reflected by the altered metadata, he or she will later discover that the license will not provide access to that underlying content.

Thus an improved method and data structure of protection mechanisms are desirable to accomplish delivery of protected data or content.

### SUMMARY OF THE ILLUSTRATED EMBODIMENTS

Disclosed are methods and systems (and related data structures) for processing metadata in files, including media files, so that an alteration or falsification of the metadata can be detected. According to certain embodiments of the invention, the metadata includes hash values and digital signatures that were generated by a content server. These hash and signature values can be used by a client to authenticate the metadata.

In one aspect, a file has a first portion and a second portion, wherein the first portion consists of metadata and the second portion is comprised of data that is other than metadata. A first set of metadata adapted for storage in a first location in the file is selected. A hash value is created and is stored in a second location in the file. The hash value is a function of the first set of metadata and a function of other than the data in the second portion. A digital signature that is a function of at least the hash value is created.

In another aspect, the file comprises a media file, wherein the second portion is comprised of media data. The first portion includes the first set of metadata.

In another aspect, the media file comprises a MPEG file. The first location is either a movie-level user data box or a track-level user data box. The second location is another box contained within a movie (“moov”) box.

In an alternative embodiment, a data structure comprises a first portion and a second portion. The first portion consists of metadata and the second portion is comprised of data that is other than metadata. A set of encrypted data, that is other than encrypted metadata, is stored in the second portion. A first set of metadata is stored in a first location in the first portion, and a hash value is stored in a second location in the first portion. Second and third sets of metadata are stored in third and fourth locations, respectively, in the first portion. The third set of metadata is adapted for use in decrypting the set of encrypted data. The hash value is a function of the first and second sets of metadata. Finally, a digital signature is stored in a fifth location in the first portion and is a function of at least the hash value and the third set of metadata.

There are additional aspects to the present inventions. It should therefore be understood that the preceding is merely a brief summary of some embodiments and aspects of the present inventions. Additional embodiments and aspects of the present inventions are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of the preferred embodiments, taken in conjunction with the accompanying drawings of which:

FIG. 1 is a simplified block diagram of a content providing system according to some embodiments for use in distributing content;

FIG. 2 is a simplified block diagram of a hardware environment for a content server device according to one embodiment of the invention;

FIG. 3 is a simplified diagram of a data structure of an item of digital content according to some embodiments of the invention;

FIG. 4 is a simplified diagram of a data structure of a box component of an item of digital content;

FIG. 5 is a simplified diagram of a data structure of other box components of an item of digital content according to some embodiments of the invention;

FIG. 6 is a simplified diagram of a data structure of another item of digital content according to some embodiments of the invention; and

FIG. 7 is a simplified flow diagram of a method of processing metadata according to an embodiment of the invention.

### DETAILED DESCRIPTION

Reference will now be made in detail to embodiments of the present invention, examples of which are illustrated in the accompanying drawings, wherein like reference numerals refer to like elements throughout. It is understood that other embodiments may be utilized and structural and operational changes may be made without departing from the scope of the present invention.

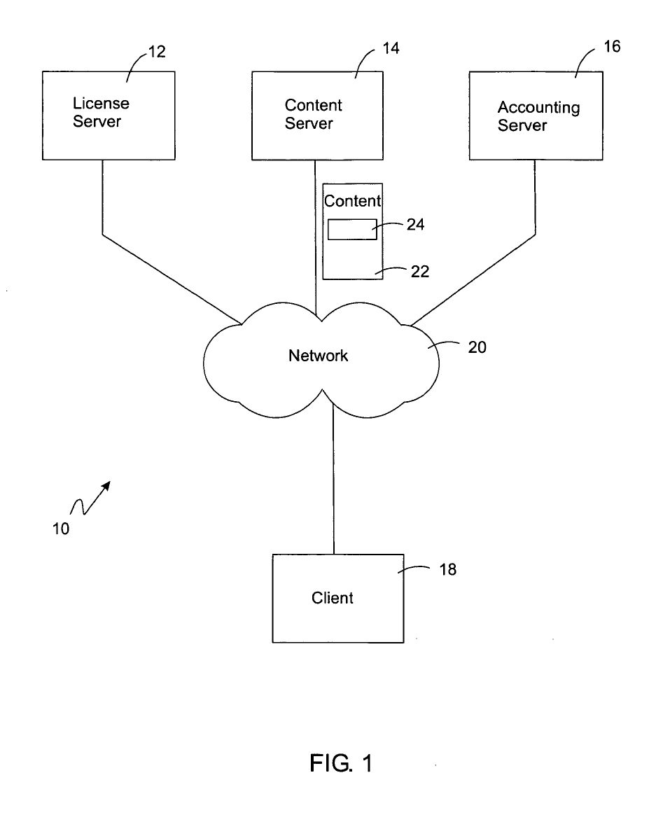

Referring to FIG. 1, there is shown an exemplary configuration of a content providing system 10 to which certain embodiments of the present invention are applied. The content providing system 10 handles protected content which can include video data, audio data, image data, text data, etc. A license server 12, a content server 14, and an accounting server 16 are each connected to a client 18 and to each other via a network 20 which is the Internet for example. In this example, only one client 18 is shown, but those skilled in the art will appreciate that any number of clients may be connected to the network 20.

The content server 14 provides the client 18 with an item of content 22 having metadata 24 with certain data protection attributes. The license server 12 grants a license necessary for the use by the client 18 of the content 22. The accounting server 16 is used to bill the client 18 when it is granted the license 22. While the illustrated embodiment shows three servers in communication with the client 18, it will be understood that all of these server functions could be included in a fewer or greater number of servers than the three which are shown here.

According to certain embodiments of the invention, the metadata 24 includes hash values and digital signatures that were generated by the content server 14. As explained in greater detail below, these hash values and digital signatures can be used by the client 18 to authenticate the metadata 24.

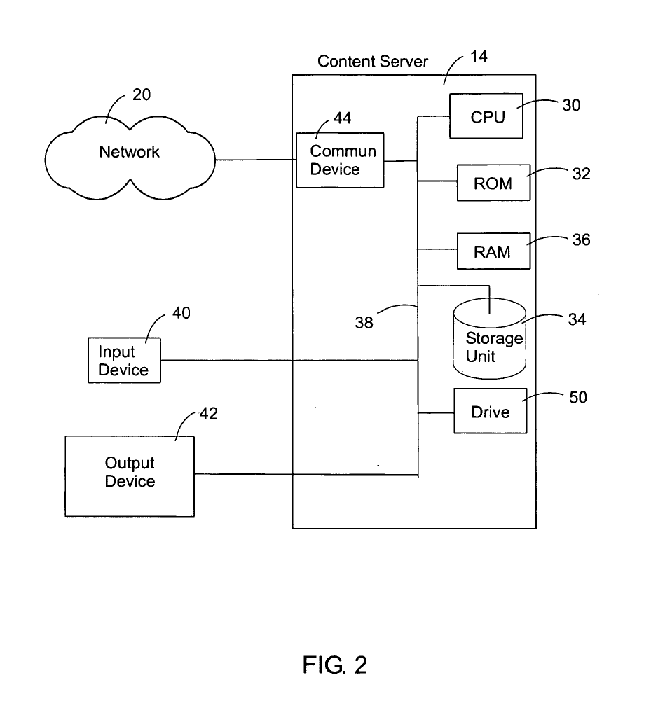

FIG. 2 illustrates an exemplary configuration of the content server 14. Referring to FIG. 2, a central processing unit (CPU) 30 executes a variety of processing operations as directed by programs stored in a read only memory (ROM) 32 or loaded from a storage unit 34 into a random access memory (RAM) 36. The RAM 36 also stores data and so on necessary for the CPU 30 to execute a variety of processing operations as required.

The CPU 30, the ROM 32, and the RAM 36 are interconnected via a bus 38. The bus 38 further connects an input device 40 composed of a keyboard and a mouse for example, an output device 42 composed of a display unit based on CRT or LCD and a speaker for example, the storage unit 34 based on a hard disk drive for example, and a communication device 44 based on a modem, network interface card (NIC) or other terminal adaptor for example.

The ROM 32, RAM 36 and/or the storage unit 34 stores operating software used to enable operation of the content server 14. The communication device 44 executes communication processing via the network 20, sends data supplied from the CPU 30, and outputs data received from the network 20 to the CPU 30, the RAM 36, and the storage unit 34. The storage unit 34 transfers information with the CPU 30 to store and delete information. The communication device also communicates analog signals or digital signals as may be necessary for communication with other devices.

The bus 38 is also connected with a drive 50 as required on which a magnetic disk, an optical disk, a magneto-optical disk, or a semiconductor memory for example is loaded for computer programs or other data read from any of these recording media being installed into the storage unit 34.

Although not shown, the client 18, the license server 12, and the accounting server 16 (FIG. 1) are also each configured as a computer which has basically the same configuration as that of the content server 14 shown in FIG. 2. While FIG. 2 shows one configuration of the content server 14, alternative embodiments include any other type of computer device.

In the content providing system 10, the license and content servers 12, 14 send a license (not shown) and the content 22 to the client 18. (FIG. 1) The license is required to enable the client 18 to use (i.e., render, reproduce, copy, execute, etc.) the protected content which typically is in encrypted form.

Each item of content is configured and encrypted by a service provider organization using one or more encryption keys. The client 18 decrypts and reproduces the received item of content on the basis of the license information and the content. In some embodiments, the license information includes usage rights, such as for example, the expiration date beyond which the item of content may not be used, the number of times that the content may be used, the number of times that the content can be copied to a recording medium such as a CD for example, and the number of times that the content may be checked out to a portable device.

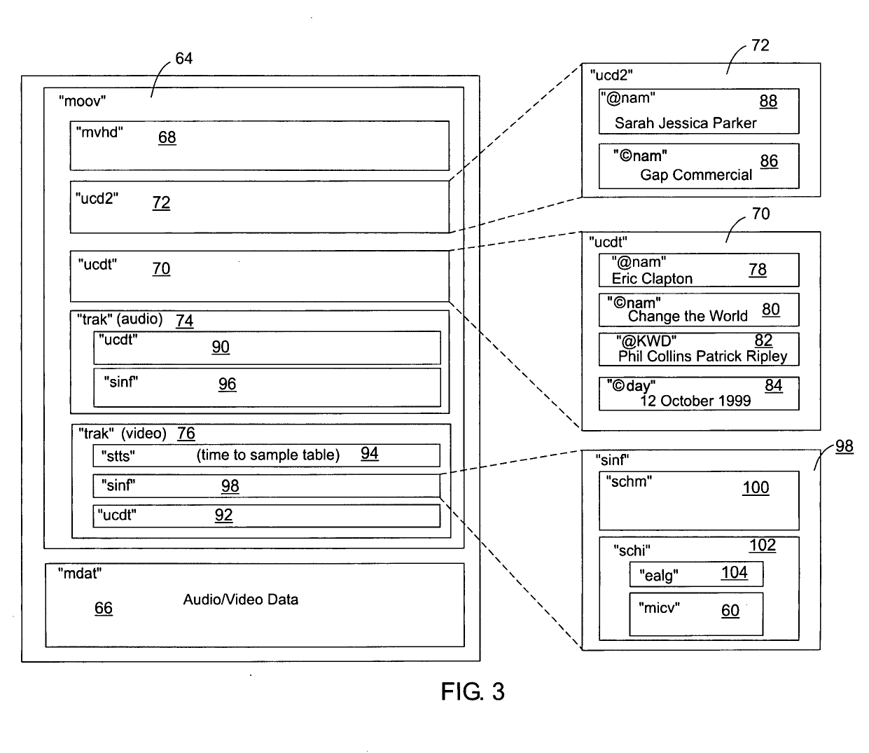

FIG. 3 illustrates simplified view of a data structure for securing metadata in accordance with an embodiment of the invention.

Referring to FIG. 3 a modified MPEG-4 (sometimes called “MP4”) data structure is shown having a first portion and a second portion comprising, respectively, of metadata and underlying audio-visual content. The MPEG (Moving Picture Experts Group) has developed MPEG-4 which is a multimedia compression standard format for arranging multimedia presentations containing moving image and audio data. In addition to MPEG-4, there are other MPEG formats as well for use with media data.

MPEG-4 is an object-oriented file format, where the data is encapsulated into structures called “atoms” or “boxes.” The MPEG-4 format separates all the presentation level information (i.e. the metadata) from actual multimedia data samples (sometimes called media data), and puts the metadata into one integral structure inside the file, which is called the “movie box”. This type of file structure can be generally referred to as a “track-oriented” structure, because the metadata is separated from the media data. The media data is referenced and interpreted by the metadata boxes. While FIG. 3 illustrates several boxes, an actual MPEG-4 file contains many additional boxes not shown here.

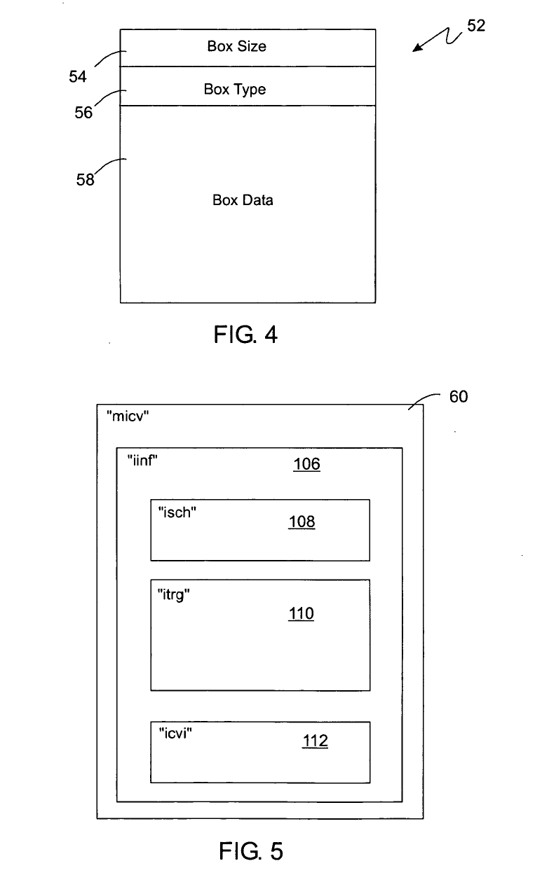

The boxes (or atoms) have a common structure, such as the box 52 shown in FIG. 4. In the box 52, the first four (4) bytes are set in a size field 54 for indicating a size of the box 52 in bytes. The next four (4) bytes are set in a type field 56 for identifying a type of the box 52. The type of the box 52 is identified by four characters, i.e. “a four character code.” For example, “moov” is set in the case of the movie box, and “mdat” is set in the case of the movie data box. By matching these four characters, the type of the box can be identified. Then, after the type field 56, a box data field 58 or section is stored. A structure of this box data field 58 has a syntax defined in each box in accordance with a purpose. Using this box file structure, storage can be arranged in a nested or hierarchical fashion where certain boxes can be inserted into other boxes.

In the illustrated embodiment of FIG. 3, a new box type is defined. As will be described in further detail below, a metadata integrity check value (“micv”) box 60 holds certain hash and signature values for use in authenticating the metadata.

First however, an overview of the function of certain of the other illustrated boxes will be described. Referring still to FIG. 3, the MPEG-4 data structure includes one movie (“moov”) box 64 and at least one media data (“mdat”) box 66. The moov box 64 stores the information, etc., necessary for decoding the metadata of the entire MPEG-4 file, i.e., an encoded codec data stream of a media, for example information describing an attribute, an address, etc. for data decoding. The mdat box 66 stores an actually encoded codec stream of a media, i.e., content data such as a video stream or an audio stream.

The moov box 64 encapsulates several other boxes, including a movie header (“mvhd”) box 68, a first movie-level user data (“ucdt”) box 70, a second movie-level user data (“ucd2”) box 72, an audio track (“trak”) box 74 and a video track (“trak”) box 76. The mvhd box 68 contains information which governs the whole presentation. This box defines the time scale and duration information for the entire movie, as well as its display characteristics.

The audio and video track boxes 74, 76 contain other boxes which hold meta information on each media according to a type of the media included in the moov box 64. Track boxes define a single track of a movie. Each track is independent of the other tracks in the moov box 64 and carries its own temporal and spatial information. Tracks are used specifically to contain media data (media tracks), and to contain modifier tracks.

As explained in further detail below, generally speaking user data boxes allow one to define and store data associated with an MPEG-4 object, such as a movie, track, or media. This includes both information that MPEG-4 looks for, such as copyright information or whether a movie should loop, and arbitrary information—provided by and for the user's application—that MPEG-4 ignores. The movie-level user data box's immediate parent is the movie box and contains data relevant to the movie as a whole. The track-level user data box's immediate parent is the track box and contains information relevant to that specific track. An MPEG-4 file may contain many user data boxes.

In the illustrated example, the movie-level user data boxes 70, 72 have box types of “ucdt” and “ucd2,” respectively. Inside each user data box are a plurality of user data entry boxes, each of which contains a set of user data. For example, user data entry boxes can be used to store sets of user data corresponding to a movie's window position, playback characteristics, creation information, title, and genre, as well as the names of actors, names of authors, etc. As shown in FIG. 3, user data entry boxes within the first movie-level ucdt box 70 include a “@nam” box 78 for a set of user data corresponding to the name of an artist, which in this example is Eric Clapton, a “©nam” box 80 for the name of a song, “Change the World,” a “@KWD” box 82 for keyword information, such as “Phil Collins,” “Patrick Ripley,” etc. and a “©day” box 84 for the date that the work was created. Other sets of user data corresponding to many other items of user information can be included as well.

The second movie-level user data (“ucd2”) box 72 includes movie-level data for other of the media data contained in the MPEG-4 file. In this example, this is user data entry information associated with a commercial, with a “©nam” box 86 for the name of the commercial title, “Gap Commercial” and a “@nam” box 88 for the lead actor appearing in the commercial, “Sarah Jessica Parker.”

The audio and video track boxes 74, 76 contain track-level user boxes 90, 92. These are used to store information similar to that described for the movie-level user boxes 70, 72, except that the track-level information relates only to the particular track (e.g. audio or video) associated with the parent box and need not include information associated with other tracks or with the movie-level. In some instances however some or all of the information can be the same.

Also contained within the video track box 76 is a decoding time-to-sample (“stts”) box 94. This box stores duration information for a media's samples, providing a mapping from a time in a media to the corresponding data sample. One can determine the appropriate sample for any time in a media by examining a time-to-sample box table, which is contained in the time-to-sample box 94.

Also contained within the audio and video track boxes 74, 76 are protection scheme information (“sinf”) boxes 96, 98. Sinf boxes are parent boxes for other boxes containing information relating to DRM or other data security-related methods. These other boxes contain information required both to understand any encryption transforms that are applied and their parameters, and also to find other information such as the kind and location of the key management system.

Contained within the video track sinf box 98 is a scheme type (“schm”) box 100 that defines the kind of DRM system and the structure of the security information used. Also contained within the video track sinf box 98 is a scheme information (“schi”) box 102. This is a container that is only interpreted by the DRM scheme being used. Information that the encryption system needs is stored here. The content of this box is a series of boxes whose type and format are defined by the scheme declared in the scheme type box 102.

Contained within the schi box 102 is an encryption algorithm (“ealg”) box 104. As the name implies, this box contains information about the identity of the encryption algorithm and contains an initial vector used to decrypt the content located in the mdat box 66.

Also contained within the schi box 102 is the metadata integrity check value (“micv”) box 60. Referring to FIG. 5, the micv box 60 is a container for an integrity information (“iinf”) box 106 and for other boxes not shown in FIG. 5. The iinf box 106, in turn, is the container for an integrity check scheme (“isch”) box 108, an integrity target (“itrg”) box 110, and an integrity check value (“icvi”) box 112, as well as other boxes not shown in FIG. 5.

The isch box 108 is used to identify the DRM system for protecting the metadata. This can be a different DRM system than the DRM system identified in the schm box 100 that is used for the content, or it can be the same DRM system.

The itrg box 110 is used to identify the target metadata for calculating hash values, or in other embodiments, for digital signatures. The data in this box includes target type information, target sub-type information, and target entry information. Target type information specifies which metadata box will be used for calculating the hash values. As described in more detail below, this identifies which user data boxes, e.g., the ucdt or ucd2 boxes, either at the movie-level or at the track-level, from which data is retrieved for hash calculations. Target subtype information specifies whether the user data boxes will be movie-level metadata or track-level metadata. Finally, target entry information specifies which user data entry boxes that are contained within the user data boxes (that are identified by the target type and subtype) will actually be used for the hash calculations, or in other embodiments, for the digital signatures.

Thus, for example, assume that one of the ucdt boxes contained the following user data entry boxes with the following entries:

@nam Eric Clapton

©name Change the World

@KWD=Phil Collins Patrick Ripley

©gen=Rock Pops

©day=Oct. 12, 1999.

Then assume that the target entry defined a hash target as follows:

Target entry=“@nam” “@KWD” “©gen”.

In this example, the hash target resulting from the target entry is the concantenation of the target entry data, and would be: “Eric Clapton Phil Collins Patrick Ripley Rock Pops.” A resulting hash value (sometimes referred to as an “integrity check value”) taken from this target entry is then stored in the icvi box 112. The icvi box 112 not only stores this integrity check value, but also stores an identification of the algorithm that was used to calculate the hash value. In one embodiment, the hash algorithm used is the SHA-1 algorithm. However, other embodiments may use different hash algorithms.

Thus when a client device receives content, the client will locate and access the target entry data in the itrg box 110, and then perform a hash calculation on that data to obtain a local hash value. This local hash value will be compared against the integrity check value (stored in the icvi box 112) that was calculated by the content server for that same target entry data. If the values match, then the user can have confidence that the metadata likely was not altered by unauthorized persons.

While FIGS. 3 and 5 illustrate the boxes contained within the video track sinf box 98, it should be understood that the audio track sinf box 96 contains a similar data structure comprised of similar schm, schi, ealg and micv boxes.

In alternative embodiments, rather than using hash algorithms, digital signatures are used. In other words, for example, rather than calculating a hash of the target entry data, a digital signature of the target entry data is used.

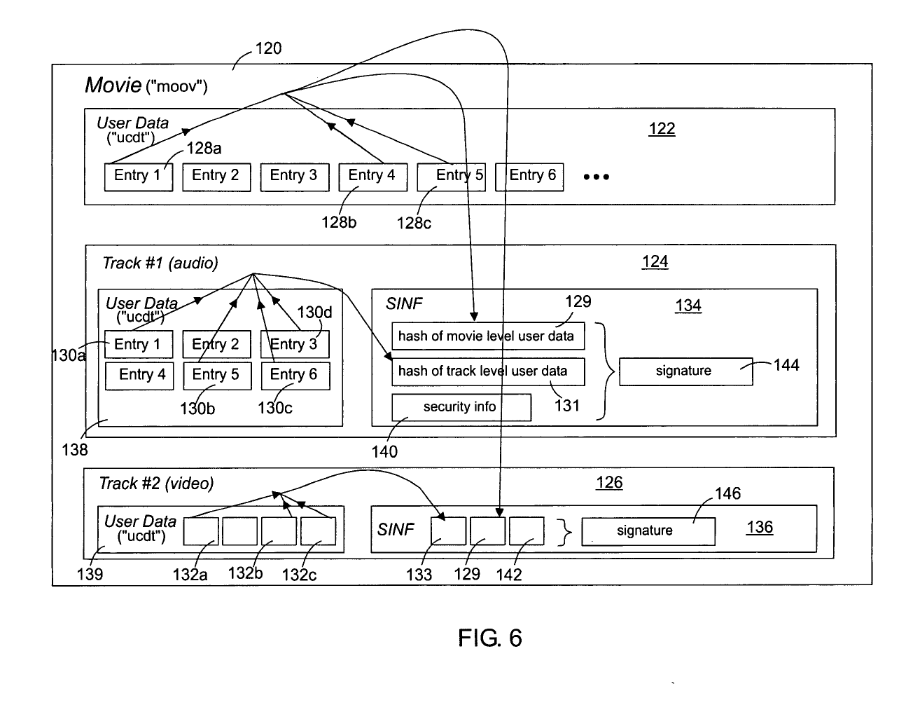

FIG. 6 is a simplified diagram showing the selection of certain metadata to be hashed and the placement of the corresponding hash values within a data structure. In this example, three movie-level user data entries 128a, 128b, 128c are selected from a movie-level ucdt box 122 which in turn is located within a moov box 120. In this illustration, these entries are merely designated “Entry 1,” “Entry 4,” and “Entry 5” for convenience. However they are similar to the data corresponding to the entries shown in FIG. 3 as “@nam,” “@KWD,” etc. located in the movie-level ucdt box 70. A hash 129 of these three entries is calculated by a content provider server and is placed in two locations: (1) in an icvi box (not shown) that is nested within a track 1 sinf box 134 that is located within a track 1 (audio) box 124, and (2) in another icvi box (not shown) that is nested within a track 2 sinf box 136 that is located within a track 2 (video) box 126.

Additionally, four track-level user data entries 130a-130d are selected from a track 1 ucdt box 138 and are used by the content provider server to calculate another hash value 131 which is placed in the icvi box (not shown) that is nested within the track 1 (audio track) sinf box 134. Similarly, three track-level user data entries 132a, 132b, 132c are selected from a track 2 (video track) ucdt box 139 and are used to calculate yet another hash value 133 which is placed in the icvi box (not shown) that is nested within the track 2 (video track) sinf box 136. (FIG. 6 illustrates the hash values as being located directly in the sinf boxes 134, 136 for ease of illustration only; it being understood that in fact these values are located in the icvi boxes which in turn are nested several levels below the sinf boxes as seen in FIGS. 3 and 5.)

In addition to the hash values stored in the icvi boxes (which are nested in the sinf boxes 134, 136), the track 1 and track 2 sinf boxes 134, 136 each contain at least one additional security information box 140, 142 that stores a set of metadata adapted for use in decrypting media data, such as for example, decryption keys or sub-keys, content license attribute data, or other DRM-related security data, etc. To prevent the successful tampering of the hash data or the data in the additional security information boxes 140, 142, a track 1 digital signature 144 is created as a function of the movie-level hash 129, the track 1 level hash 131 and the track 1 security information box 140 data. This track 1 signature 144 is placed in the track 1 sinf box 134. Similarly, a track 2 digital signature 146 is calculated for the movie-level hash 129, the track 2 level hash 133 and the track 2 security information box 142 data. This track 2 signature 146 is placed in the track 2 sinf box 136. These digital signatures can be verified by the client with public keys obtained from the content provider server (or some other external source) in order to confirm that the hash and security information data likely have not been tampered.

While one embodiment of the invention is described herein by a modified MPEG-4 file format, those skilled in the art will appreciate that other embodiments may be implemented in other MPEG file formats, as well as in other media formats, other streaming applications and formats, and in other types of content or data.

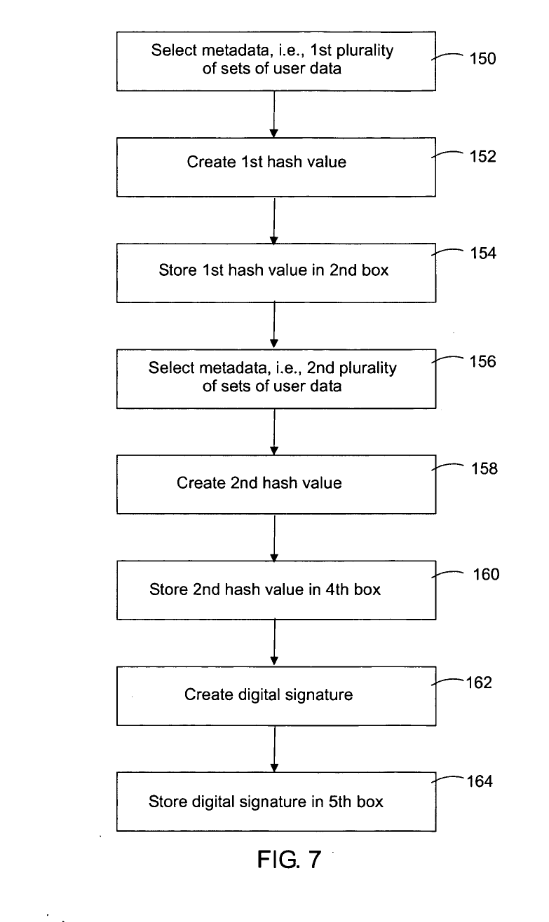

FIG. 7 is a simplified flow diagram of a method of processing metadata in a media file according to one embodiment of the invention. A first plurality of sets of user data is selected. 150 The first plurality is adapted for storage in a first box in the media file. Then a first hash value is created wherein the first hash value is a function of the first plurality of sets of user data. 152 Next, the first hash value is stored in a second box in the media file. 154

A second plurality of sets of user data is then selected, wherein the second plurality is adapted for storage in a third box in the media file. 156 Then, a second hash value is created as a function of the second plurality of sets of user data. 158 The second hash value is then stored in a fourth box in the media file. 160 Finally, a digital signature is created that is a function of at least the first and second hash values 162, and then stored in a fifth box in the media file. 164

Thus there are disclosed methods and systems (and related data structures) for processing metadata in files, including media files, so that an alteration or falsification of the metadata can be detected. According to certain embodiments, the metadata includes hash values and digital signatures that were generated by a content server. These hash values and digital signatures can be used by a client to authenticate the metadata.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A method of processing metadata in a file having a first portion and a second portion, wherein the first portion consists of metadata and the second portion is comprised of data that is other than metadata, the method comprising:
selecting a first set of metadata adapted for storage in a first location in the file;
creating a hash value as a function of the first set of metadata and as a function of other than the data in the second portion; and
storing the hash value in a second location in the file.

2. The method of claim 1 further comprising creating a digital signature as a function of at least the hash value.

3. The method of claim 1 wherein the file comprises a media file, wherein the second portion is comprised of media data, and wherein the first portion includes the first set of metadata.

4. The method of claim 3 wherein the media file comprises a MPEG file.

5. The method of claim 3 wherein the media file comprises a MPEG file and wherein the first location is one of a movie-level user data box and a track-level user data box, and wherein the second location is another box contained within a movie box.

6. The method of claim 1 further comprising selecting a second set of metadata adapted for storage in a third location in the file, wherein creating the hash value as a function of the first set of metadata includes creating the hash value as a function of the first and second sets of metadata.

7. The method of claim 6 further comprising creating a digital signature as a function of at least the hash value.

8. The method of claim 6 further comprising:
selecting a third set of metadata adapted for storage in a fourth location in the file and for use in decrypting a set of encrypted data, wherein the set of encrypted data is other than encrypted metadata and is adapted for storage in the second portion; and
creating a digital signature as a function of at least the hash value and the third set of metadata.

9. A method of processing metadata in a media file, the method comprising:
selecting a first plurality of sets of user data, wherein the first plurality is adapted for storage in a first box in the media file;
creating a first hash value as a function of the first plurality of sets of user data;
storing the first hash value in a second box in the media file;
selecting a second plurality of sets of user data, wherein the second plurality is adapted for storage in a third box in the media file;
creating a second hash value as a function of the second plurality of sets of user data; and
storing the second hash value in a fourth box in the media file.

10. The method of claim 9, wherein creating the first hash value as a function of the first plurality of sets of user data comprises creating the first hash value as a function of a concatenation of the first plurality of sets of user data, and
wherein creating the second hash value as a function of the second plurality of sets of user data comprises creating the second hash value as a function of a concatenation of the second plurality of sets of user data.

11. The method of claim 9 further comprising:
creating a digital signature as a function of at least the first and second hash values; and
storing the digital signature in a fifth box in the media file.

12. The method of claim 9 wherein the media file includes a first track of media data, a second track of media data, a first track box for containing metadata related to the first track of media data, and a second track box for containing metadata related to the second track of media data,
wherein the first box is located other than in the first and second track boxes; and
wherein the second, third and fourth boxes are located in the first track box.

13. The method of claim 12 further comprising storing the first hash value in a fifth box located in the second track box.

14. The method of claim 9 wherein the media file includes a first track of media data, a second track of media data, a first track box for containing metadata related to the first track of media data, and a second track box for containing metadata related to the second track of media data,
wherein the first and second boxes are located in the first track box; and
wherein the third and fourth boxes are located in the second track box.

15. The method of claim 9 further comprising:
selecting a third plurality of sets of user data, wherein the third plurality is adapted for storage in a fifth box in the media file;
creating a third hash value as a function of the third plurality of sets of user data; and
storing the third hash value in a sixth box in the media file.

16. The method of claim 15 further comprising:
creating a first digital signature as a function of at least the first and second hash values;
storing the first digital signature in a seventh box in the media file;
creating a second digital signature as a function of at least the first and third hash values; and
storing the second digital signature in an eighth box in the media file.

17. The method of claim 15 wherein the media file includes a first track of media data, a second track of media data, a first track box for containing metadata related to the first track of media data, and a second track box for containing metadata related to the second track of media data,
wherein the first box is located in other than the first and second track boxes;
wherein the second, third and fourth boxes are located in the first track box; and
wherein the fifth and sixth boxes are located in the second track box.

18. The method of claim 17 further comprising storing the first hash value in a seventh box located in the second track box.

19. A method of processing metadata in a file having a first portion and a second portion, wherein the first portion consists of metadata and the second portion is comprised of data that is other than metadata, the method comprising:
selecting a first set of metadata adapted for storage in a first location in the file, wherein the first set of metadata is other than a hash value;
creating a digital signature as a function of at least the first set of metadata and as a function of other than the data in the second portion; and
storing the digital signature in a second location in the file.

20. The method of claim 19 wherein the file comprises a media file, wherein the second portion is comprised of media data, and wherein the first portion includes the first set of metadata.

21. The method of claim 20 wherein the media file comprises a MPEG file.

22. The method of claim 21 wherein the media file comprises a MPEG file and wherein the first location is one of a movie-level user data box and a track-level user data box, and wherein the second location is another box contained within a movie box.

23. The method of claim 19 further comprising selecting a second set of metadata adapted for storage in a third location in the file, wherein the second set of metadata is other than a hash value, and wherein creating the digital signature as a function of at least the first set of metadata includes creating the digital signature as a function of at least the first and second sets of metadata.

24. A data structure comprising:
a first portion and a second portion, wherein the first portion consists of metadata and the second portion is comprised of data that is other than metadata;
a first set of metadata stored in a first location in the first portion; and
a hash value stored in a second location in the first portion, wherein the hash value is a function of the first set of metadata and a function of other than the data in the second portion.

25. The data structure of claim 24 further comprising a digital signature stored in a third location in the first portion, wherein the digital signature is a function of at least the hash value.

26. The data structure of claim 24 wherein the data structure comprises a media file, and wherein the second portion is comprised of media data.

27. The data structure of claim 26 wherein the media file comprises a MPEG file.

28. The data structure of claim 26 wherein the media file comprises a MPEG file having a movie box, and wherein the first location is one of a movie-level user data box and a track-level user data box, and wherein the second location is another box contained within the movie box.

29. The data structure of claim 24 further comprising:
a second set of metadata stored in a third location in the first portion,
wherein the hash value is a function of the first and second sets of metadata.

30. The data structure of claim 29 further comprising a digital signature stored in a fourth location in the first portion, wherein the digital signature is a function of at least the hash value.

31. The data structure of claim 29 further comprising:
a third set of metadata stored in a fourth location in the first portion;
a set of encrypted data stored in the second portion, wherein the set of encrypted data is other than encrypted metadata, and wherein the third set of metadata is adapted for use in decrypting the set of encrypted data; and
a digital signature stored in a fifth location in the first portion, wherein the digital signature is a function of at least the hash value and the third set of metadata.

32. An article of manufacture for use in processing metadata in a file and for use by a device having a processing unit, wherein the file has a first portion and a second portion, and wherein the first portion consists of metadata and the second portion is comprised of data that is other than metadata, said article of manufacture comprising:
at least one computer usable media including at least one computer program embedded therein, the at least one computer program being adapted to cause the device to perform:
selecting a first set of metadata adapted for storage in a first location in the file;
creating a hash value as a function of the first set of metadata and as a function of other than the data in the second portion; and
storing the hash value in a second location in the file.

33. A system for processing metadata in a file having a first portion and a second portion, wherein the first portion consists of metadata and the second portion is comprised of data that is other than metadata, the system comprising:
a device having a processing unit capable of executing software routines; and
programming logic executed by the processing unit, wherein the programming logic comprises:
means for selecting a first set of metadata adapted for storage in a first location in the file;
means for creating a hash value as a function of the first set of metadata and as a function of other than the data in the second portion; and
means for storing the hash value in a second location in the file.

34. The system of claim 33 further comprising means for creating a digital signature as a function of at least the hash value.

35. The system of claim 33 wherein the file comprises a media file, wherein the second portion is comprised of media data portion, and wherein the first portion includes the first set of metadata.

36. The system of claim 35 wherein the media file comprises a MPEG file.

37. The system of claim 35 wherein the media file comprises a MPEG file having a movie box and wherein the first location is one of a movie-level user data box and a track-level user data box, and wherein the second location is another box contained within the movie box.

38. The system of claim 33 further comprising means for selecting a second set of metadata adapted for storage in a third location in the file, wherein the means for creating the hash value as a function of the first set of metadata includes means for creating the hash value as a function of the first and second sets of metadata.

39. The system of claim 38 further comprising means for creating a digital signature as a function of at least the hash value.

40. The system of claim 38 further comprising:
means for selecting a third set of metadata adapted for storage in a fourth location in the file and for use in decrypting a set of encrypted data, wherein the set of encrypted data is other than encrypted metadata and is adapted for storage in the second portion; and
means for creating a digital signature as a function of at least the hash value and the third set of metadata.
